(19) United States
(12) Patent Application Publication
(10) Pub. No.: US 2007/0134466 A1
(43) Pub. Date: Jun. 14, 2007

(54) Sandwich panels with subsonic shear wave speed

(76) Inventors: Shankar Rajaram, Los Angeles, CA (US); Tongan Wang, Savannah, GA (US); Steven R. Nutt, Irvine, CA (US)

Correspondence Address: FISH & RICHARDSON, PC, P.O. BOX 1022, MINNEAPOLIS, MN, 55440-1022, US

(21) Appl. No.: 11/495,901

(22) Filed: Jul. 28, 2006

Related U.S. Application Data
(60) Provisional application No. 60/703,652, filed on Jul. 29, 2005.
(60) Provisional application No. 60/793,403, filed on Apr. 19, 2006.

(51) Int. Cl. B32B 3/12; B32B 3/00

(52) U.S. Cl. 428/116; 428/73

(57) ABSTRACT

Aircraft panels are formed of a honeycomb core material and the skin. The honeycomb core material and the skin are selected to provide subsonic wave speed across the panel, thereby reducing sound transmission.

### CROSS-REFERENCE TO RELATED APPLICATIONS

This application claims priority to U.S. Provisional Applications Ser. Nos. 60/703,652, filed on Jul. 29, 2005 and 60/793,403 filed on Apr. 19, 2006. The disclosure of the prior applications are considered part of (and are incorporated by reference in) the disclosure of this application.

### BACKGROUND

Structural panels used in applications such as aircraft, buildings and transportation vehicles vibrate and transmit sound due to unavoidable external sources of excitation. Panels used in aircraft applications need to have high specific strength and stiffness and very low weight. Sandwich panels with cores made of honeycomb, balsa or foam often meet these criteria, especially for floors and fuselage.

However, the same property combination may lead to higher transmission and radiation of airborne noise than expected, based solely on panel mass.

### SUMMARY

Structure and methods to reduce airborne noise across a broadband frequency range transmitted by a vibrating honeycomb sandwich floor panel is described.

### BRIEF DESCRIPTION OF THE DRAWINGS

FIG. 1 shows a honeycomb sandwich panel;

FIG. 2 shows an enhancement of the low shear, thin skin, high density core;

FIG. 3 shows an enhancement of the high shear, thick skin, low density core;

FIG. 4 shows the flow chart for the design of subsonic panels;

FIG. 5 shows a graph reflecting the improvement of transmission loss between subsonic and supersonic wave speed panels;

FIG. 6 shows a graph of the sound transmission loss of airplane floors;

FIG. 7 shows a graph of the difference between mass law performance of floor panels; and

FIG. 8 shows a graph with calculated wave speeds for honeycomb sandwich panels.

### DETAILED DESCRIPTION

The general structure and techniques, and more specific embodiments which can be used to effect different ways of carrying out the more general goals, are described herein.

The inventors believe that the reason for the sound transmission is based on the supersonic wave speed for energy waves in the panel. These energy waves efficiently exchange energy with the cabin environment of the airplane or other vehicles.

The present application describes optimizing the panel to have a subsonic wave speed in the frequency range of interest. This can make the panels more inefficient as transmitters and radiators of sound. Moreover, this provides superior sound attenuation for a given panel mass.

An embodiment describes a panel design with a core that has a constant subsonic sheer mode for transmitted waves. In the embodiment, the coincidence frequency is shifted to above 8000 Hz. The panel is also optimized to meet other design constraints including mechanical performance constraints and weights. In effect, this forms a passive noise rejection technique which varies skin and core thickness, densities, and elastic moduli.

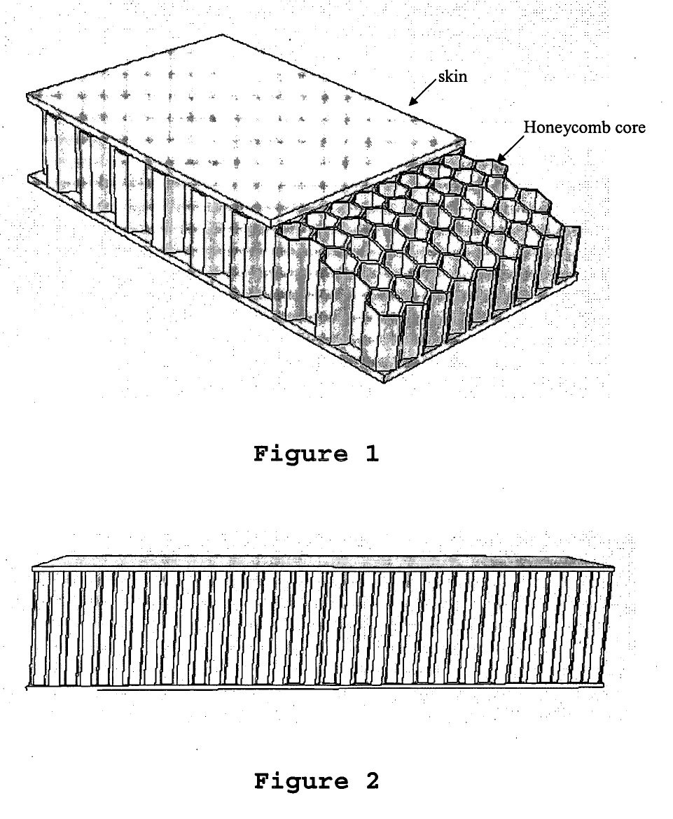

FIG. 1 illustrates a first embodiment showing a honeycomb sandwich panel which has predominantly sheer modes over bending modes at most, e.g. more than half, the frequencies of interest. According to the embodiments, the panels become inherently noise attenuated, requiring less damping material. Reduction in the damping material reduces their weight and hence increases payloads. This may be critical and extremely advantageous in commercial aircraft. This also reduces labor costs which would otherwise be required to pack the damping material.

The panel of FIG. 1 has parameters such that the shear wave speed will remain subsonic at most of these frequencies. The subsonic speed targeted is between ⅔ of Mach 1 and Mach 1. The subsonic speed for waves in the panel makes the panel an inefficient exchanger of energy with the surroundings.

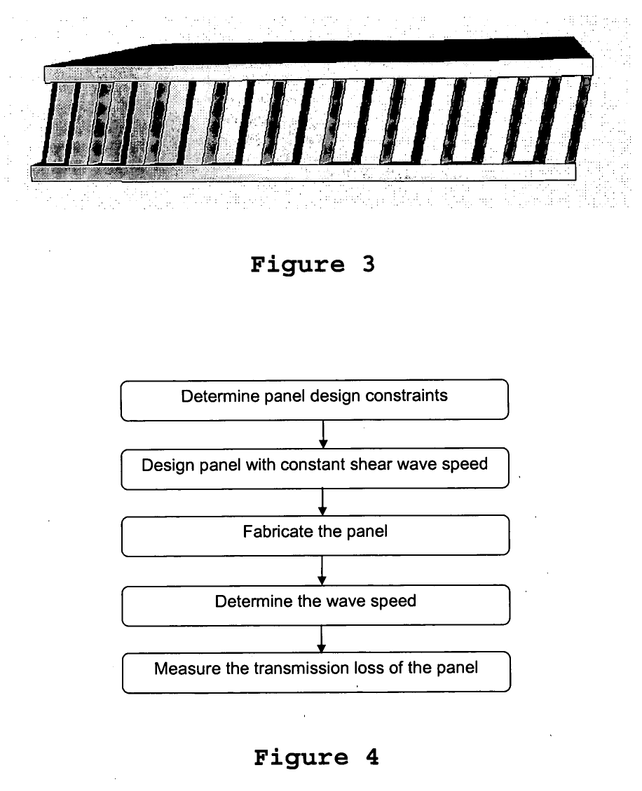

The predominant subsonic shear wave speed is achieved by using a low-modulus core and an increased skin-to-core thickness ratio. This enhancement of shear motion is shown in FIG. 2 and FIG. 3. In an embodiment, the core is a sound insulating material, e.g. Nomex® honeycomb with a density that lies between 1.8 pcf and 5 pcf (pounds per cubic foot). The core is also made of Kevlar® honeycombs or balsa wood or forms. The one-side skin-to-core thickness ratio can range anywhere between 0.02 and 0.1. The skin can be of any high modulus fiber/fabric and resin combination like carbon fiber—phenolic or glass fiber—epoxy.

The density and modulus of the core can be varied to strike a balance between the requisite acoustic performance, mechanical performance and weight constraints. The mechanical properties considered in the optimization include flexural strength, flexural modulus, core shear strength, and compressive strength. The flexural modulus can be tripled by increasing the skin thickness while remaining within the acoustic and weight constraints. Depending upon the core densities, the core strength can be as low as half the value for the lowest density compared to the highest density. The compressive strength can be one-third the value for the lowest density compared to the highest density.

As an example of the present art, design parameters for 5 panels and a reference panel are described in Table 1 and Table 2. The core densities presented are 1.8 pcf and 3 pcf.

TABLE 1
Panel design parameters.

| 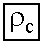 | 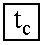 | 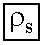 | 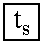 | 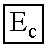 | 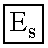 | |
|---|---|---|---|---|---|---|
| | | | | × 10\hat{ }6 | × 10\hat{ }9 | |
| Panel Code | kg/m3 | m | kg/m3 | m | N/m2 | N/m2 |
| X-Reference | 144 | 0.0096 | 1600 | 0.0003 | 750 | 100 |
| PA −1.8 pcf - | 28.8 | 0.0087 | 1600 | 0.00075 | 450 | 100 |
| 2.5S | | | | | | |
| PB −1.8 pcf - | 28.8 | 0.009 | 1600 | 0.0006 | 450 | 100 |
| 2S | | | | | | |
| PC −3 pcf - 2S | 48 | 0.009 | 1600 | 0.0006 | 450 | 100 |
| PD −3 pcf - | 48 | 0.0087 | 1600 | 0.00075 | 450 | 100 |
| 2.5S | | | | | | |
| PE −3 pcf - 3S | 48 | 0.0084 | 1600 | 0.0009 | 450 | 100 |

TABLE 2
Mass, bending stiffness and core shear wave speed.

| | surface mass | D | Cₛ |
|---|---|---|---|
| Panel Code | kg/m² | N/m² | m/s |
| X - Reference | 2.81 | 1675 | 666 |
| PA −1.8 pcf - 2.5S | 3.14 | 3816 | 243 |
| PB −1.8 pcf - 2S | 3.17 | 3151 | 273 |
| PC −3 pcf - 2S | 3.34 | 3151 | 350 |
| PD −3 pcf - 2.5S | 4.05 | 3816 | 314 |
| PE −3 pcf - 3S | 4.77 | 4435 | 286 |

| | | |
|---|---|---|
| 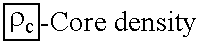 | 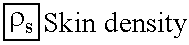 | 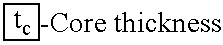 |
| 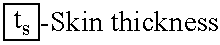 | 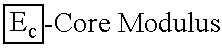 | 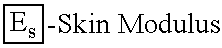 |

D-Bending stiffness Cₛ - Shear speed

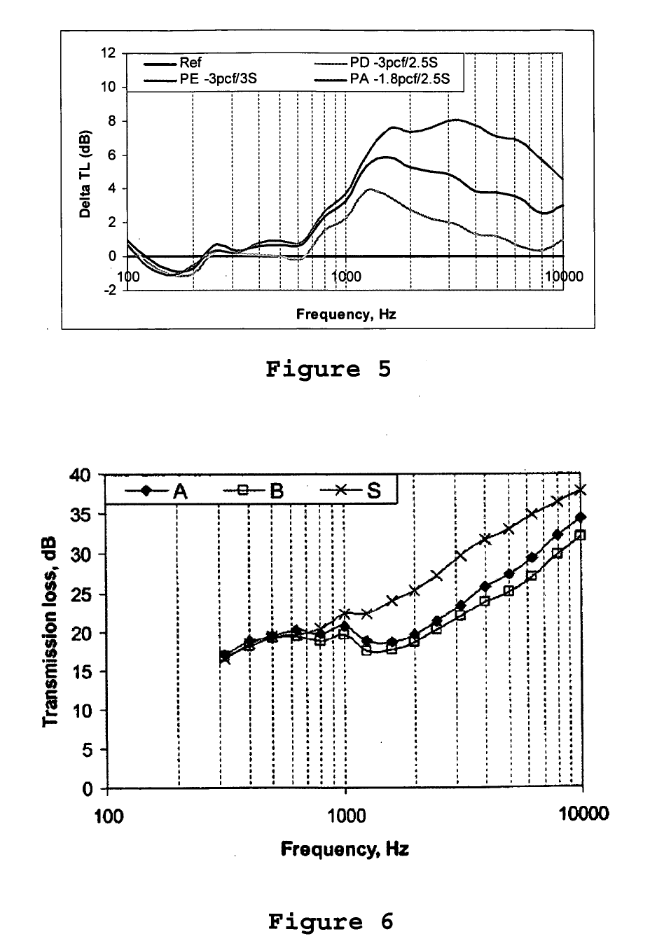

To demonstrate the impact of subsonic wave speed design on the acoustic performance of the panel, transmission loss improvement of panels made according tot eh present system with subsonic wave speed (PA, PB, PD, and PE) with Mach between 0.7 and 1 is compared to a reference panel with supersonic wave speed (X), as shown in FIG. 5. A sound transmission loss improvement of 507 dB at middle and higher frequencies is demonstrated in the experimental measurements for panel PB, which has significantly subsonic shear wave speed. Panels with incremental shear wave speed show decrement in transmission loss (TL).

These materials may be used for an airplane floor or wall panels. According to an embodiment, the materials are made of a high modulus fiber laminate skins and an orthotropic Nomex®/Kevlar® honeycomb core. These lightweight panels are optimized for mechanical performance that results in poor acoustic performance. The commercially available floor panels are considerably inefficient in their usage of mass when compared to a single panel of same mass.

Airborne sound transmission loss (TL) is used to estimate the acoustic barrier properties of these floor panels¹. The panels have a complicated acoustic behavior that are dependent on the different mechanical motions like panel bending, skin bending and core shear motions^{2, 3}. The wave propagations related to these motions and their relation to the speed of sound in ar at different frequency regimes determines the subsequent performance of the panels. The low-frequency region is stiffness-controlled, while the mid-frequency region is mass-controlled. Typically these panels have a critical frequency, which is the lower limiting coincidence frequency corresponding tot eh grazing angle of incidence, between 1-2 KHz. Kurtze and Watters derived the relationships between the mass and mechanical properties of a sandwich panel to the panel wave speeds at different frequency regimes. Their model assumes the existence of three idealized frequency regimes; the first regime is dominated by the total panel bending, the second regime is dominated by the core shear, and the third regime is controlled by the bending of the skins. Their design for inherently quieter sandwich panels emphasized on significantly subsonic core shear wave speeds for the panels in the frequency range of interest. The core modulus influences the core shear wave speed. To make a thin sandwich panel acoustically superior, a low density core would be required. However, this could lower the mechanical performance of the floor panel.
¹ Shankar Rajaram, Tongan Wang, Puneet Jain, Steve Nutt, “Noise transmission loss in composite sandwich panels”:, SAMPE, Long Beach, California, May 17-21, 2004

² Kurtze, G., and Watters, B. G., “New wall design for high transmission loss or high damping”, J. Acoust. Soc. Am., 31, 739-48, 1959.

³ Davis, E. B., “Designing Honeycomb panels for noise control”, American Institute of Aeronautics and Astronautics, AIAA-99-1917, 1999.

The objective of this application is to design a practical quieter honeycomb sandwich panel based on Kurtze and Watter's theory for floor panel applications.

Kurtze and Watters Theory

Kurtze and Watters based their model for acoustics of sandwich panel on wave impedances. The impedance of a symmetric sandwich panel due to the panel mass (Z_{M}) , bending of the panel (Z_{b}), skin contribution to the shear of the core (Zₛₕ₁) , and the core shear (Zsh₂) are given consideration.

Then the total impedance is obtained by combining the above impedances (eqn. 1), analogous to an electrical circuit. The mass terms are connected in series to the stiffness terms. The stiffness terms are connected parallel to each other. The shear stiffness term contains serial contributions from two skins and one core.

$${Z}_{p} = {Z}_{m} + \frac{{Z}_{b} \cdot ( 2 {Z}_{sh 1} + {Z}_{sh 2} )}{{Z}_{b} + ( 2 {Z}_{sh 1} + {Z}_{sh 2} )} \qquad Equation 1$$

For special cases, the polynomial is reduced to,

$$\frac{{c}_{s}^{4}}{{c}_{b}^{4}} {c}_{p}^{6} + {c}_{s}^{2} {c}_{p}^{4} - {c}_{s}^{4} {c}_{p}^{2} - {c}_{b}^{′4} {c}_{s}^{2} = 0 \\ where \\ {c}_{b}^{4} = \frac{{D}_{p} {ω}^{2}}{{M}_{p}} = bending wave speed of the plate , \\ {c}_{b}^{4} = \frac{2 {D}_{sk} {ω}^{2}}{{M}_{p}} = bending wave s peed of the skins , \\ and {c}_{s}^{2} = \frac{{G}_{c}}{{M}_{p}} = shear wave speed of the core . \qquad Equation 2$$

The panel bending stiffness (Dₚ), and skin bending stiffness (Dₛₖ) are given by

$$\begin{matrix}{D}_{p} = \frac{{E}_{sk} J}{( 1 - {v}_{sk}^{2} )} ; \\ {D}_{sk} = \frac{{E}_{sk} {t}_{sk}^{3}}{12 ( 1 - {v}_{sk}^{2} )} .\end{matrix}$$

In the above expressions, Mₚ is the mass of the panel, G_{c} is the shear modulus of the core, Eₛₖ is the Young's modulus of the skin, υₛₖ is the Poisson's ratio of the skin material, J is the moment of inertia for the cross section of the sandwich panel, tₛₖ is the thickness of the skin, and G_{c} is the shear modulus of the core.

Evan Davis normalized the panel wave speed to speed of sound and arrived at the save speeds of the different regimes in the form of panel geometry, mass density and the elastic properties of the materials used from the above polynomial:

$$\begin{matrix}{c}_{b} = {[ \frac{{ω}^{2} {t}_{sk} 2 {( 1 + {t}_{c} / {t}_{sk} )}^{2}}{4 ( 1 + {ρ}_{c} {t}_{c} / 2 {ρ}_{sk} {t}_{sk} )} ( \frac{{E}_{sk}}{{ρ}_{sk} ( 1 - {v}^{2} )} ) ]}^{1 / 4} & Equation 3 \\ {c}_{s} = {[ \frac{1}{( 1 + 2 {ρ}_{sk} {t}_{sk} / {ρ}_{c} {t}_{c} )} ( \frac{{G}_{c}}{{ρ}_{c}} ) ]}^{1 / 2} & Equation 4 \\ {c}_{b}^{′} = {[ \frac{{ω}^{2} {t}_{sk}^{2}}{24 ( 1 + {ρ}_{c} {t}_{c} / 2 {ρ}_{sk} {t}_{sk} )} ( \frac{{E}_{sk}}{{ρ}_{sk} ( 1 - {v}^{2} )} ) ]}^{1 / 4} & Equation 5\end{matrix}$$

C_{b} and c_{b}′ are proportional to the skin material save speed,

$${c}_{msk} = \sqrt{\frac{{E}_{sk}}{{ρ}_{sk} ( 1 - {v}^{2} )}} ,$$

and cₛ is proportional to the core material wave speed,

$${c}_{mc} = \sqrt{\frac{{G}_{c}}{{ρ}_{c}}} .$$

The panel wave regimes and the transition zones T_{I} and T_{II} are summarized as:

$$\begin{matrix}{c}_{b} < {T}_{I} < {c}_{s} < {T}_{II} < {c}_{b}^{′} & Equation 6 \\ {T}_{I} \frac{1}{π {t}_{sk}} ( \frac{1}{( 1 + {t}_{c} / {t}_{sk} )} ) \sqrt{\frac{{( {ρ}_{c} {t}_{c} / 2 {ρ}_{sk} {t}_{sk} )}^{2}}{( 1 + {ρ}_{c} {t}_{c} / 2 {ρ}_{sk} {t}_{sk} )}} ( \frac{{c}_{mc}^{2}}{{c}_{msk}} ) & Equation 7 \\ {T}_{II} = \frac{\sqrt{3}}{π {t}_{sk}} \sqrt{\frac{{( {ρ}_{c} {t}_{c} / 2 {ρ}_{sk } {t}_{sk} )}^{2}}{( 1 + {ρ}_{c} {t}_{c} / 2 {ρ}_{sk} {t}_{sk} )}} ( \frac{{c}_{mc}^{2}}{{c}_{msk}} ) & Equation 8\end{matrix}$$

The mechanical parameter used as a design constraint was the static bending stiffness D given by

$$D = \frac{{E}_{sk} {{t}_{sk} ( {t}_{sk} + {t}_{c} )}^{2}}{2 ( 1 - {v}_{sk}^{2} )} .$$

Experimental Procedure

The sound transmission loss (TL) was tested at a facility that has an asymmetric reverberant source room and a symmetric anechoic receiver room mounted on floating floors. The samples tested had a size of 1.067 m by 1.067 m and was secured in the window between the two chambers using steel slats along the four edges of the test panel. The small-scale reverberant source room had a volume of 15 cubic meters and 9 non-parallel walls. The receiver room was a rectangular shaped anechoic room with a volume of 15 cubic meters. Pink noise was generated in the source room using an omni sound speaker. The spatial average of the incident sound pressure was measured using a pressure microphone mounted on a rotating boom. The transmitted sound was measured using an intensity probe that was mounted on a traverse system. The surface intensity of the transmitted sound was averaged from measurements taken at discrete points on an 11×11 grid. A standard steel panel was used to calibrate the chamber. The chamber was calibrated for all frequency bands above 315 Hz.

Samples

Three samples were chosen for the study. All the samples had carbon-phenolic laminates for skins and Nomex® honeycomb for core. Panels A and B were commercial grade airplane floor panels. The design of Panel S was based on Kurtze and Watters model for quieter panels. It was designed to meet the subsonic criteria that core shear speed, cₛ˜⅔ speed of sound. The design details of the panels are given in table 3. Table 4 shows the calculated wave speeds of the three panels based on equations 4-8.

TABLE 3
Mechanical and geometrical details of the samples

| | Cell | ρ_{c} | t_{c} | ρₛ | tₛ | M | G × 10⁶ | E × 10⁹ |
|---|---|---|---|---|---|---|---|---|
| Panel | size m | kg/m³ | m | kg/m³ | m | kg/m² | Nm⁻² | Nm⁻² |
| A | 0.004 | 144 | 0.0096 | 1600 | 0.0003 | 2.8 | 108.3 | 100 |
| B | 0.003 | 80 | 0.0096 | 1600 | 0.0003 | 2.2 | 63.25 | 100 |
| S | 0.004 | 28.8 | 0.0087 | 1600 | 0.00075 | 3.1 | 18 | 100 |

TABLE 4
Wave speed details of the samples based
on Kurtze and Watters formulation

| | D | Cs | Cb | Cms | CmL | T1 | T2 |
|---|---|---|---|---|---|---|---|
| Panel | Nm | m/s | m/s | m/s | m/s | Hz | Hz |
| A | 1675 | 666 | 3 | 867 | 8439 | 2643 | 151052 |
| B | 1675 | 593 | 3 | 889 | 8439 | 1797 | 102711 |
| S | 3816 | 243 | 6 | 791 | 8439 | 248 | 5411 |

Results and discussion

FIG. 6 shows that the TL of panels A and B have a dip at ˜1600 Hz. This is the coincidence dip caused by the matching of panel speed with the speed of air for the grazing angle of incidence. The TL trend increases after 2 KHz, but the TL values are considerably lower compared to panel S. The TL curve for panel S does not show any dip between 1 KHz and 2 KHz.

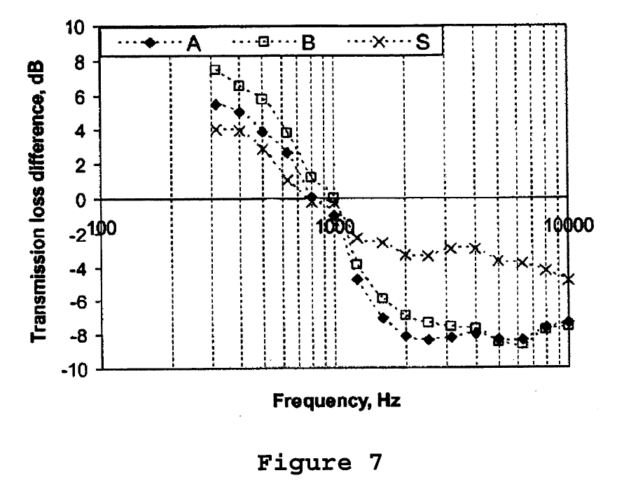

FIG. 7 shows the TL difference, which is the measured TL minus the mass law calculated TL. The TL difference is plotted to get a relative idea of the acoustic performance of the panels for a given mass. Panel A shows the poorest mass law performance above 1 KHz. Panel S. shows the best mass law performance. The negative deviation from mass law above 1 KHz is considerably lower for panel S compared to panel A and B. The TL improvement for the subsonic floor panel is comparable to the SEA predication made by Evan Davis for a similar design.

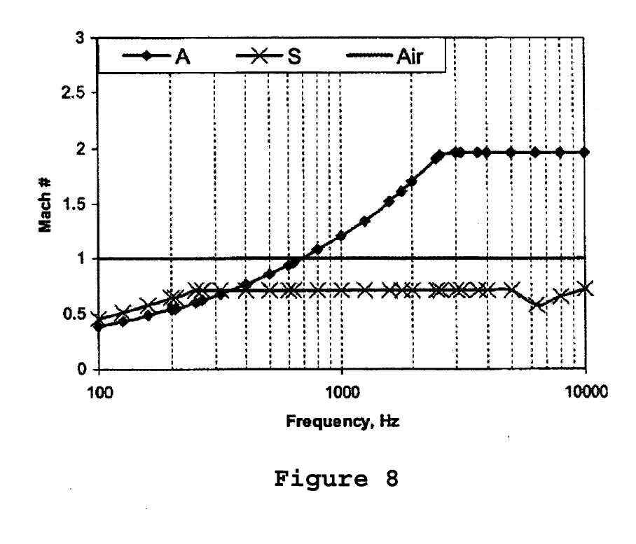

The improvement in TL for panel S can be attributed to the supersonic core shear wave speeds for panels A and B, and a subsonic wave speed for panel S, as listed in Table 4. FIG. 8 shows the wave speed plotted for panels A and S calculated using the Kurtze and Watters formulation. It can be seen that the panel wave speed coincides with speed of sound at around 1 KHz for panel A. For panel C, the shear wave speed is about two-thirds the speed of sound for most frequency bands above 1 KHz.

The static bending stiffness (D) of panel S is almost twice the static bending stiffness of panel A and B as shown in table 4. This increased beam loading capacity for the panel S due to thicker skins is expected to take most kinds of loads that an airplane floor panel is subjected to. Moreover, panel S is only ˜10% heavier than panel A. This shows that such panels can be designed for practical applications.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other materials with similar or analog characteristics.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. A panels for use on an aircraft, comprising a first sound insulating material, and a second material, forming a skin for the honeycomb, where the materials are selected to maintain the acoustic transmission across the honeycomb at a subsonic speed.

2. A panel as in claim 1, wherein said first material is a honeycomb material.
